(19) United States
(12) Patent Application Publication
(10) Pub. No.: US 2013/0311290 A1
(43) Pub. Date: Nov. 21, 2013

(54) Website based on user current location

(71) Applicant: Ashraf M. Khwaja, Hopkinton, MA (US)

(72) Inventor: Ashraf M. Khwaja, Hopkinton, MA (US)

(21) Appl. No.: 13/474,546

(22) Filed: May 17, 2012

(51) Int. Cl. G06Q 30/02

(52) U.S. Cl. CPC G06Q 30/0261
USPC 705/14.58

(57) ABSTRACT

This new invention will be implemented in a software system. It will be a new process that will improve user experience. This new invention allow user to find and open website based on user location. It will allow websites to serve the user based on their local needs. It will also eliminate the need of typing web address, searching site, scanning barcode etc. to open website if user is present at the location. This new invention will also provide easy information from the web about the famous places if the user is present at the location without even knowing the exact name of the location. Mobile Application will provide the user interface. Web Service will be used by Mobile Application to get the websites list by passing two parameters longitude and latitude. The Database data will be used by the Web Service to create the list.

### BACKGROUND OF INVENTION

This new invention is in the field of software technology. Currently it is hard for websites to serve user based on their local needs. User has to drill down to different layers to get the information based on local needs. It also requires user to type web address, search site, scan barcode etc. to open a website. This new invention will allow user to find a website based on location with simple clicks which will improve user experience and allow businesses to server customers based on local needs

### BRIEF SUMMARY OF THE INVENTION

This new invention is a process which will allow user to find website based on user current location. User will be able to find and open website in few very simple steps. User will open software application on mobile device which will provide a list of business websites around that location. User will click one of the businesses in the list which will open the business website base on user local needs.

This new process will be implemented in a software system. There will be three main components of the software system Mobile Application, Web Service and Database. User will interact through Mobile Application. Mobile Application will call Web Service to get the list of business websites around current location. Web service will provide the list using data stored in the database. Each item on the list will contain extra information about the location of business that the website may use to provide information based on user local needs.

This new invention will allow easy access to the website without the need of typing web address, searching site, scanning barcode etc. It will also open endless possibilities for the websites to provide information based on user local needs.

### BRIEF DESCRIPTION OF THE SEVERAL VIEWS OF THE DRAWINGS

FIG. 1 Show the process of finding website based on location.

FIG. 2 Show the main functionality of the Mobile Application which is part of the software system.

### DETAILED DESCRIPTION OF THE INVENTION

This new invention is in the field of software technology. It will be a process implemented in a software system that will allow the user to conveniently open a website if he/she is present around the business location. For Example, if the user is present at Wal-Mart then he will be able to easily open the Wal-Mart website from this new invention with simple clicks on the mobile device. There are at least two big advantages of using this invention compared to other ways to open business website. First, this new invention will allow easy access to the website without the need of typing web address, searching site, scanning barcode etc. Second, it will also open endless possibilities for the websites to provide information to the user based on local needs. There is additional benefit; if user is at some historical or famous place then user will be available to open its information from the web using this new software system without even knowing the name of that place.

This new process requires a location coordinates longitude and latitude, a software method that will find the websites list and a database table that will contain columns longitude, latitude, website name and web address. Longitude and latitude parameters will be passed to software method and software method will create and return the websites list using the database table.

This new process will be implemented in a software system to find and open website base on user location. There will be at least three components of the software system Mobile Application, Web Service and Database. Mobile Application will provide interface to the user. It will call Web Service with two parameters longitude and latitude to get the list of websites. Web Service will get the list provided by the Database.

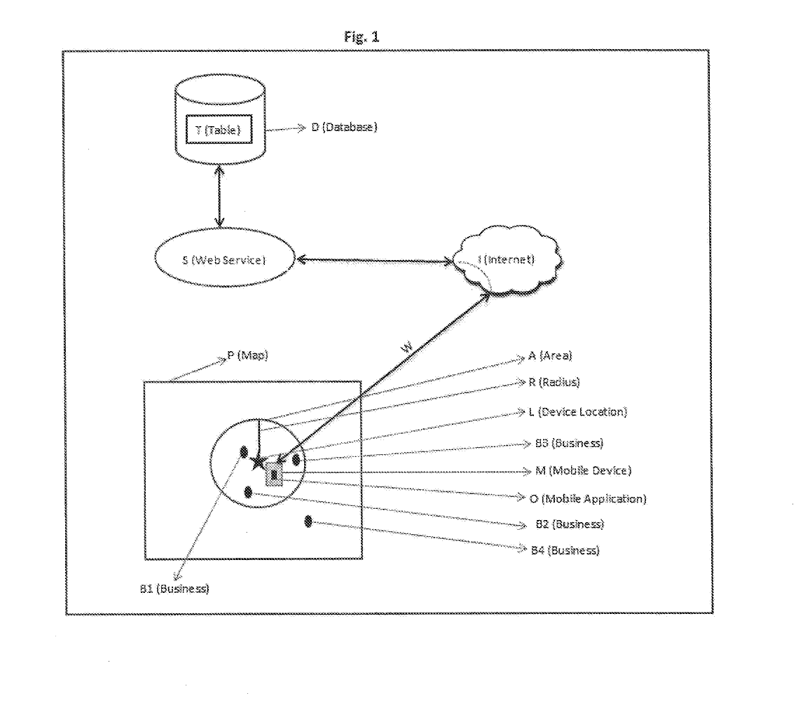

FIG. 1 in the drawings shows user is at location L with Mobile Device M. User will open Mobile Application O on the mobile device M. Mobile Application O will send request to the Web Service S through the Web Method W. Mobile Application O will pass two parameters longitude and latitude to the Web Method W. Mobile Application O will communicate to Web Service S through Internet I. Web Service S will receive the request and find the list of all website around location L. Web Service S will use Table T in the Database D to generate the list. Table T will contain columns Longitude, Latitude, Website Name and Website Address, which will be used to determine the list. A on the FIG. 1. shows the Area that will be used to search the websites and R is the radius of the Area A. Web Service S will find all the websites within Area A and few other important websites like town's website of that location. In FIG. 1 there are four businesses B1, B2, B3 and B4. Web Service S will find only B1, B2 and B3 websites since they are in the Area A. After creating websites list, Web Service S will send it to Mobile Application O through the Web Method W. Mobile Application O will display the websites list on the mobile device screen. User will click the website to open it on the browser window of the Mobile Device M. Web address will contain the longitude and latitude of the business location that website may use to provide information based on user local needs.

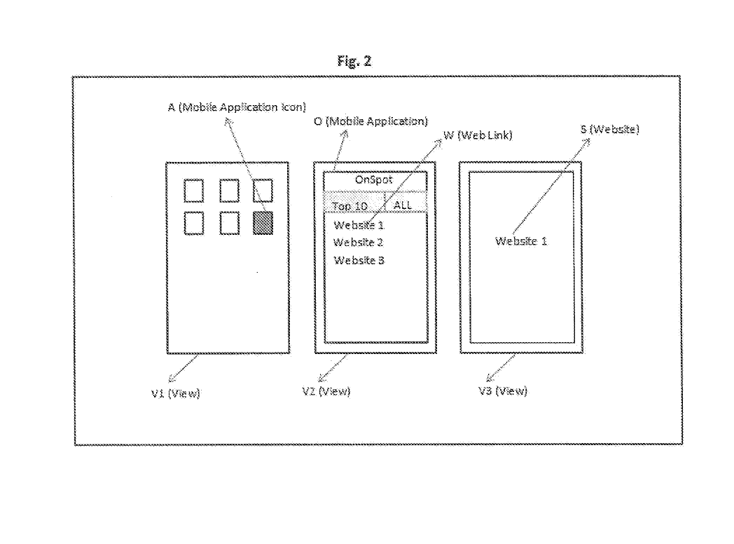

This new software system will be very easy to use. FIG. 2 in the drawings shows how this mobile application will be used. FIG. 2 depicts the basic user interface of the mobile application. By no means, FIG. 2 defines the design of the mobile application. FIG. 2 shows the three views of the mobile device screen V1, V2 and V3. V1 shows general view of the mobile device which shows different applications on the screen. On view V1, A is the mobile application icon. After user clicked A it will open the mobile application. V2 shows the screen once the A is clicked on V1 and mobile application O is opened. V2 shows the website list those business locations are present, around the user location. W is the website that user clicked on V2. When user click Won V2. screen, Mobile Application O will launch interne browser application on the mobile device and display the website that user clicked on V2 as shown in V3.

This new invention will allow users to open a website conveniently using the user's current location and it will also provide the way to the websites to serve users based on their local needs.

1. I claim I have invented a new process to find website base on user location.

2. I claim this new invention will open endless possibilities for the businesses to serve their costumers based on their local needs by passing business location's longitude and latitude parameter to its website.

3. I claim this new invention will provide easy access to information through the web about famous places if user is present at the location.
